(19) United States
(12) Patent Application Publication
(10) Pub. No.: US 2019/0235989 A1
(43) Pub. Date: Aug. 1, 2019

(54) QUEUE-LESS ANALYSIS OF APPLICATION CODE

(71) Applicant: salesforce.com, inc., San Francisco, CA (US)

(72) Inventors: Josh Lewis, Lakeland, TN (US); Andrew Appleton, Cookham (GB); Guðmundur Bjarni Ólafsson, San Francisco, CA (US); Ike DeLorenzo, San Francisco, CA (US); Hector Simpson, Somerset (GB)

(21) Appl. No.: 15/885,720

(22) Filed: Jan. 31, 2018

(51) Int. Cl. G06F 11/36

(52) U.S. Cl. CPC G06F 11/3612; G06F 11/3688; G06F 11/3684; G06F 11/3664

(57) ABSTRACT

A method for analysis of software programs or applications is disclosed. The method may include an execution broker application executing on a compute resource included in a computer network, receiving application code and analysis information and generating an execution environment on a different compute resource included in the computer network. The execution broker application may initiate performance of an analysis of the application code using the execution environment and storage of a result of the analysis on another compute resource included in the computer network. In response to determining the analysis has completed, the execution broker may deactivate the execution environment.

### BACKGROUND

### Technical Field

This disclosure generally relates to software testing, in particular to performing queue-less integration testing of application code.

### Description of the Related Art

During development of a software program or application, various tests may be performed to ensure the software program or application functions as intended. Such tests may vary in scope and may be performed during different stages of development of the software program or application. Once a software program or application has been tested, it may be released for general use.

In some cases, tests may be performed on a portion of code, such as, e.g., a particular class or module, for a software program or application without any external dependencies, such as connections to databases or network connectivity. Such tests are commonly referred to as “unit test” and typically execute quickly.

Other tests are performed on an entire software program or application. In such tests, all classes may be included, and as many external dependencies as practical are provided during the testing process. Tests of this nature are commonly referred to as “integration tests” or “functional tests” and may check for correct behavior of call paths and requests to external services. Integration tests may be performed on a configuration of the software program or application that is similar to the production configuration of the software program or application.

Production tests are performed on the production version of a software program or application. Such tests may test for correct behavior of the software program or application more accurately than integration tests. Production tests may be designed to not disrupt the production system, on which the software program or application is being executed.

### SUMMARY OF THE EMBODIMENTS

The present disclosure provides systems and methods for performing analysis of application code including receiving, by a execution broker application executing on a compute resource included in a computer network, application code and analysis information, and generating, by the execution broker application, at least one execution environment on a different compute resource included in the computer network. The method further includes initiating, by the execution broker application, performance of an analysis on the application code using the at least one execution environment on the different compute resource, initiating, by the execution broker application, a storage of at least one result of the analysis on another compute resource included in the computer network, and deactivating, by the execution broker application, the at least one execution environment, in response to determining the analysis has completed.

In another embodiment, the analysis information includes data specifying a plurality of application code tests.

In a non-limiting embodiment, generating, by the execution broker application, the at least one execution environment includes identifying a subset of the plurality of application code tests to be performed in parallel.

In one implementation, the method further includes, generating, by the execution broker application, a respective execution environment for a particular application code test included in the subset of the plurality of application code tests.

### BRIEF DESCRIPTION OF THE DRAWINGS

FIG. 1 is a block diagram of application code testing in a computer system.

FIG. 2 illustrates a flow diagram depicting an embodiment of a method for testing application code in a computer system.

FIG. 3 illustrates a flow diagram depicting an embodiment of a method for performing tests on application code in parallel.

FIG. 4 is a block diagram of one embodiment of a computer system including a test broker application.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited.

### DETAILED DESCRIPTION OF EMBODIMENTS

During the development of a software program or application, there may be a numerous minor changes that are continually being made to the code of the software program or application. As changes are made to the software program or application, tests, including unit and integration tests, are performed to verify operation of the software program or application.

When different developers are developing multiple software programs or applications, individual developers may submit their software program or application code, along with a list of tests to be performed, to a server that will perform the tests. The server places requested tests in a queue, and may perform the tests in the order in which they were received. By placing the requests tests in the queue, a test for a particular developer that may execute quickly may become queued behind a test for a different developer that may require a long time to execute. Such a situation may result in a long development times for some applications, which can result in delays releasing a software program and application, thereby increasing development costs. The embodiments illustrated in the drawings and described below may provide techniques for performing continuous integration tests on application code using available compute resources in a computer network, without placing the tests in a queue prior to execution.

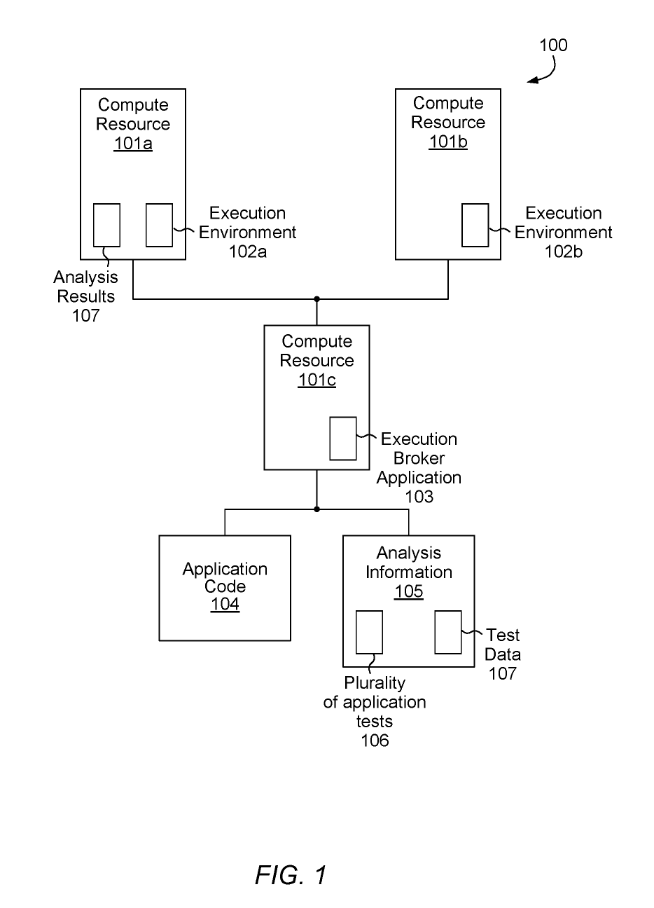

An embodiment of a computer network is illustrated in FIG. 1. In the illustrated embodiment, computer network 100 includes compute resources 101a through 101c. As used and described herein, a compute resource refers to a workstation or mobile computer device coupled to a computer network, where the workstation or mobile computer device includes one or more processors or processor cores configured to execution program instructions associated with a software program, application, and the like.

As described below, compute resources 101a through 101c may be additionally be coupled to storage devices (not shown) configured to store application code, application data, etc. In some cases, compute resources 101a through 101c may include local memory, which may be configured to store application code, application data, and the like.

Executing on compute resource 101c is execution broker application 103. In various embodiments, execution broker application 103 may receive application code 104 and analysis information 105. Application code 104 and analysis information 105 may be supplied by a software developer, and may be submitted to execution broker application 103 via a computer network, web-based interface, or any suitable method. In various embodiments, analysis information may include plurality application code tests 106 to be performed on application code 104. Alternatively or additionally, analysis information 105 may include test data 107 to be used during the analysis of application code 104. In some embodiments, a software developer may define the plurality of application code tests 106 using an application programming interface (API), or any other suitable means.

The plurality of application code tests 106 may include any suitable test to verify operation of application code 104. For example, in various embodiments, the plurality of application code tests 106 may include any suitable number of integration tests that may check for the correct behavior of call paths and requests to external services within application code 104. The plurality of application code tests 106 may also check various fields or variables within application code 104, as well as, check back-end functionality of application code 104.

Once execution broker application 103 has received application code 104 and analysis information 105, execution broker application 103 may generate execution environments on other compute resources coupled to the computer network. For example, execution broker application 103 may generate execution environment 102b on compute resource 101a and execution environment 102b on compute resource 101b. As used and described herein, an execution environment is a collection of software programs, variables, databases, and any other suitable data for use in the execution of a software program or application.

In order to generate execution environments, execution broker application may, in some embodiments, generate one or more scripts for execution on a particular compute resource. As the one or more scripts are executed, the desired software programs are activated, variables set to desired values, and the like.

Once an execution environment has been established on a compute resource, execution broker application 103 may then initiate the performance of an analysis of application code 104 using the execution environment. As noted above, the analysis may include the performance of one or more tests as specified in analysis information 105. In various embodiments, execution broker application 103 may generate one or more scripts that, when executed by a compute resource, causes the compute resource to perform the desired analysis.

During the analysis, results may be generated that may be of interested to a software developer. In some cases, the results may be values of a particular variable included in application code 104, or may be the results of operations performed by application code 104 on test data 107, or other suitable data. Execution broker application 103 may initiate the storage of such results. In various embodiments, the results may be stored on a different compute resource that where the analysis was performed. The results may be stored in local memory on the different compute resource, or a storage device coupled to the different compute resource. It is noted that, in some cases, the results may be stored on the compute resource where the application code analysis was performed.

In order to make results of the analysis available to a software developer, execution broker application 103 may generate one or more universal resource locators (URLs) that include information indicative of a storage location of the results. In various embodiments, the URLs may be durable, i.e., the URLs, and the data to which the point, are available after the analysis has been performed until they have been deliberately removed. By maintaining results of the analysis in such a fashion, software developers have access to the results from many different analyses, which may assist in debug and further development of application code 104.

In response to determining that the analysis has been completed, execution broker application 103 may deactivate the execution environment used for the analysis. By deactivating the execution environment, compute resources being consumed to maintain the execution environment may be freed for use in the established of other execution environments, or to perform other tasks. Such re-deployment of compute resources may allow, in various embodiments, the performance of many different analyses on different application codes in a short period of time relative to a queue-based analysis approach.

In some cases, execution broker application 103 may check the plurality of application code tests 106 for dependencies among the various application code tests. For example, a result of a particular application code test may be used to perform, or enable performance, of another application code test. Application code tests that have no dependencies on other application code tests may be performed in parallel. Once execution broker application 103 has identified a subset of the plurality of application code tests 106, execution broker application 103 may initiate the parallel performance of the application code tests included in the subset of the plurality of application code tests. Application code tests that have not been identified for parallel execution, may then be performed in a serial fashion, as described above by execution broker application 103.

It is noted that the embodiment depicted in FIG. 1 is merely an example. In other embodiments, different numbers of compute resources and different arrangements of compute resources are possible and contemplated.

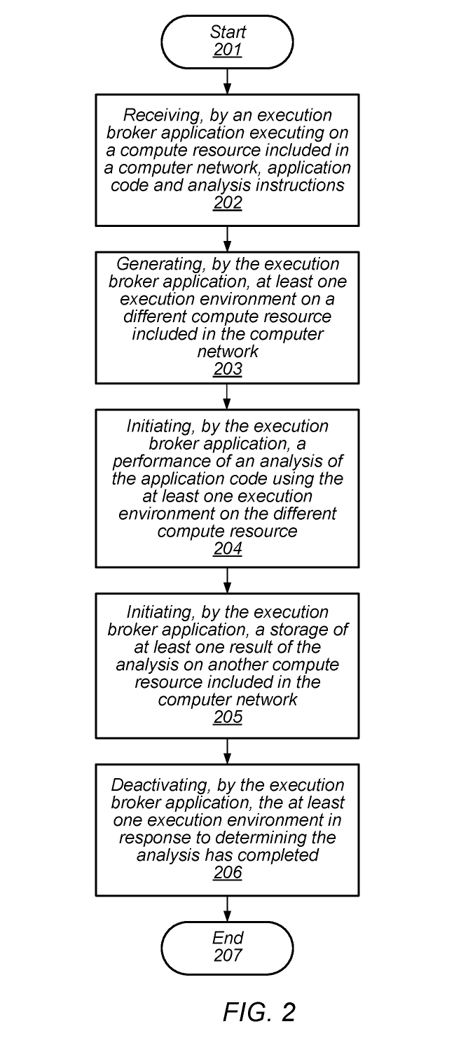

An embodiment of a method for performing tests on application code is illustrated in the flow diagram of FIG. 2. Referring collectively to the embodiment of FIG. 1 and the flow diagram depicted in FIG. 2, the method begins in block 201.

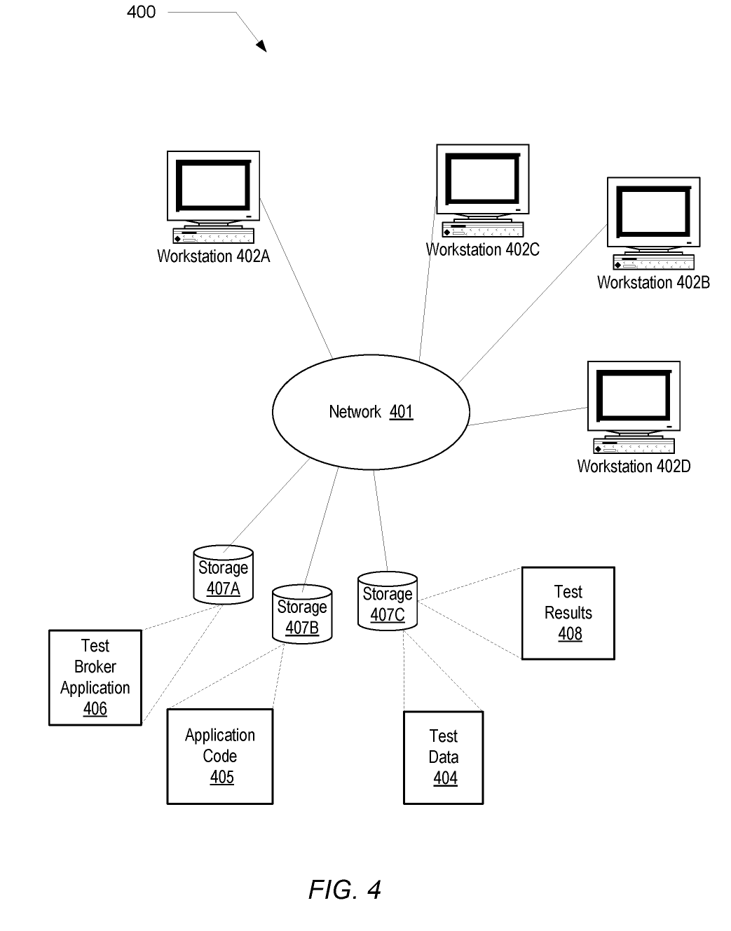

An execution broker application, such as, e.g., execution broker application 103, executing on compute resource included in a computer network, may then receive application code and analysis data (block 203). In various embodiments, the application code may correspond to source code, software libraries, and the like, for a particular software program or application. As described above, the analysis data may include a plurality of tests to be performed on the application code, as well as, test data to be used while performing the plurality of tests. As described below in regard to FIG. 4, the received application code and analysis data may be stored in a storage device associated with compute resource 101c, or in local memory included in compute resource 101c.

The execution broker application may then generate at least one execution environment on a different compute resource, such as, e.g., compute resource 101a, included in the computer network (block 203). As described above, the execution environment may include databases, variable values, compilers, libraries, and the like to generate an environment in which the application code may be executed. In some embodiments, the execution environment may be similar to a production environment for the software program or application. While similar to the production environment for the software program or application, the generated execution environment may lack access to actual data and network resources.

Once the execution environment has been generated, the execution broker application may then initiate an analysis of the application code using the execution environment on the different compute resource (block 204). In various embodiments, the execution broker application may generate one or more scripts, that when executed on the different computer resource results in the different compute resource performing the desired analysis using the generated execution environment.

The execution broker application may additionally initiate the storage of at least one result of the analysis on another compute resource, such as, e.g., compute resource 101b, included in the computer network (block 205). In various embodiments, the at least one result may include a result of a test performed on the application code, values of one or more variables included in the application code, a data file which has been generated or manipulated by the application code during execution, or any other suitable data. The at least one result may be transferred from the different compute resource to the other compute resource via a computer network.

The result may be stored on a storage device associated with the other compute resource, or in local memory included in the other compute resource. In various embodiments, a universal resource locator (URL) may be generated that includes information indicative of a location of the stored result. The result may be stored for any suitable length of time after completion of the analysis of the application code, and the URL may be durable until such time as the result is removed. By making the URL durable, a developer may have access to results of a particular analysis long after the analysis has been completed, thereby providing access to older results as an aid in debug of the application code.

The execution broker application may, in response to a determination that the analysis has completed, deactivate the execution environment (block 206). In various embodiments, the execution broker application may generate one or more scripts that upon execution by the different compute resource deactivate the execution environment. The deactivation may, in some embodiments, include the release of memory or system resource used by the execution environment, shutdown of other software programs or applications used by the application code, deletion of temporary data generated during the analysis, and the like. The method may then conclude in block 207.

It is noted that the embodiment of the method depicted in the flow diagram of FIG. 2 is merely an example. In other embodiments, different operations and different orders or operations are possible and contemplated.

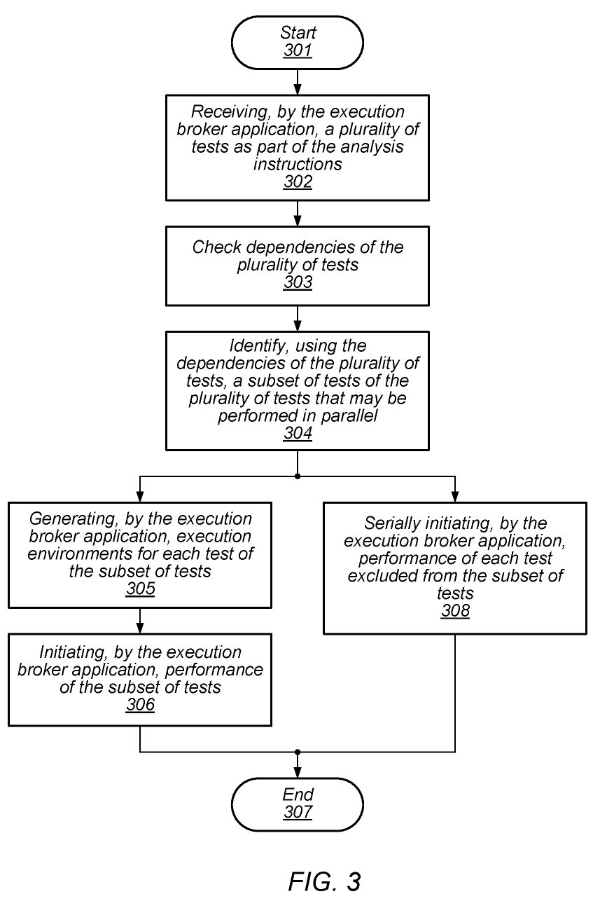

As described above, execution broker application 103 may also perform application code tests in parallel. Turning to FIG. 3, a flow diagram depicting an embodiment of a method for performing parallel tests on application code is illustrated. Referring collectively to the embodiment of FIG. 1 and the flow diagram of FIG. 3, the method begins in block 301.

Execution broker application 103 may then receive the plurality of application code tests as part of the analysis instructions (block 302). In some embodiments, the plurality of application code tests may be received along with the application code being tested, as described above in regard to method illustrated in FIG. 2. The tests included in the plurality of application code tests may be specified using an application programming interface (API), or any other suitable method for specifying software tests.

Dependencies within the plurality of application code tests may then be checked by execution broker application 103 (block 303). In some cases, results from a particular application code test may be used in performing a different application code test, or completion of the particular application code test may enable performance of another application code test. Application code tests that have no dependencies on other application code tests may be performed in parallel.

Using the determined dependencies, execution broker application 103 may then identify a subset of the plurality of application code tests that may be performed in parallel (block 304). In various embodiments, application code tests not included in the subset of the plurality of application code tests are designated for performance in a serial fashion.

Execution broker application 103 may then generate respective execution environments for each application test included in the subset of the plurality of application tests (block 305). In various embodiments, the execution environments may be generated on different compute resources, such as, e.g., compute resources 101a and 101b as depicted in FIG. 1, included in the computer network. Alternatively, the test environments may be generated using individual processor cores of compute resources, or virtual machines running on the compute resources included in the computer network.

Once the execution environments have been generated, execution broker application 103 may then initiate the performance, in parallel, of the subset of the plurality of application tests (block 306). In various embodiments, a particular test of the subset of the plurality of tests may be performed on a particular compute resource, while a different test of the particular test of the subset of the plurality of tests may be performed on a different compute resource. Once each application test of the plurality of application tests have been initiated by the execution broker application, the method may conclude in block 307. It is noted that upon completion of a given application code test included in the subset of the plurality of application code tests, one or more results of the given application code test may be scored in a fashion similar to that described above in regard to the embodiments of FIG. 1 and FIG. 2.

While generating execution environments and initiating performance of the application code tests of the subset of the plurality of application code tests, execution broker application 103 may also serially initiate the performance of the application code tests of the plurality of application code tests excluded from the subset of the plurality of application code tests (block 308). The initiation of the application code tests may be performed in a fashion in similar to that described above in regard to the embodiments of FIG. 1 and FIG. 2. Once the excluded application tests have been completed, the method may conclude in block 307.

Although the operations included in the method of FIG. 3 are depicted as being performed in a serial fashion, in other embodiments, one or more of the operations may be performed in parallel.

Turning to FIG. 4, a block diagram of one embodiment of a computer system including a test broker application. The computer system 400 includes a plurality of workstations designated 402A through 402D. The workstations are coupled together through a network 401 and to a plurality of storages designated 407A through 407C. In one embodiment, each of workstations 402A-402D may be representative of any standalone computing platform that may include, for example, one or more processors, local system memory including any type of random access memory (RAM) device, monitor, input output (I/O) means such as a network connection, mouse, keyboard, monitor, and the like (many of which are not shown for simplicity). In some embodiments, workstations 402A-402D may be included in a server farm or other collection of compute resources for use in performing distributed computing operations.

Although depicted as being depicted as being coupled to a common network in the embodiment of FIG. 4, in other embodiments, workstations 402A through 402D may be coupled to each other, as well as storage 407A through storage 407C, via multiple networks. It is noted that although the embodiment of FIG. 4 depicts four workstations, in other embodiments, any suitable number of workstations may be employed.

In one embodiment, storages 407A-407C may be representative of any type of mass storage device such as hard disk systems, optical media drives, tape drives, ram disk storage, and the like. As such, program instructions comprising the test broker application, test data, application code may be stored within any of storages 407A-407C and loaded into the local system memory of any of the workstations during execution. In various embodiments, storages 407A-407C may include portable storage media that may be used directly or removed from computer system 400. Such portable storage media, the local system memory, and the mass storages may be referred to as non-transitory computer readable storage mediums.

As an example, as shown in FIG. 4, test broker application is shown stored within storage 407A, while application code 405 is stored within storage 407B, and both test data 404 and test results 408 are stored in storage 407C. In one embodiment, test broker application 406 may be called by executed by any of workstations 402A-402D. The program instructions associated with test broker application 406 may be executed directly from storage 407A, or transferred to the local system memory of one of workstations 402A-402D, for subsequent execution. One or more processors on a given workstation of workstations 402A-402D may execute the program instructions associated with test broker application 406, or program instructions may be executed in a distributed fashion among multiple workstations of workstations 402A-402D, as desired.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A method, comprising:
receiving, by an execution broker application executing on a compute resource included in a computer network, application code and analysis information that includes a plurality of application tests and test data;
identifying, by the execution broker application, a set of the plurality of application tests that use results from other application tests of the plurality of application tests;
generating, by the execution broker application, a plurality of execution test environments on respective different compute resources included in the computer network;
initiating, by the execution broker application and using the analysis information, a performance of an analysis of the application code that includes checking, within the application code, program calls that request access to external services, wherein initiating the performance of the analysis includes:
performing the set of the plurality of application tests using a first execution test environment of a plurality of test environments; and
performing remaining application tests of the plurality of application tests using respective execution test environments of the plurality of execution test environments, wherein the remaining application tests exclude the set of the plurality of application tests;
initiating, by the execution broker application, a storage of at least one result of the analysis on another compute resource included in the computer network; and
deactivating, by the execution broker application, the first execution test environment and the respective execution test environments in response to determining the analysis has completed.

2. The method of claim 1, wherein the analysis information includes data specifying a plurality of application code tests.

3-4. (canceled)

5. The method of claim 1, wherein the analysis information includes test data, and further comprising, initiating, by the execution broker application, the performance of the analysis on the application code using the test data.

6. The method of claim 1, wherein initiating, by the execution broker application, the storage of the at least one result includes initiating, by the execution broker application, generation of a durable Universal Resource Locator (URL).

7. A non-transitory computer-readable storage medium having programming instructions stored therein that, in response to execution by a computer system, causes the computer system to perform operations comprising:
receiving, by an execution broker application executing on a compute resource included in a computer network, application code and analysis information that includes a plurality of application tests and test data;
identifying, by the execution broker application, a set of the plurality of application tests that use results from other application tests of the plurality of application tests;
generating, by the execution broker application, a plurality of execution test environments on respective different compute resources included in the computer network;
initiating, by the execution broker application and using the analysis information, a performance of an analysis of the application code that includes checking, within the application code, program calls that request access to external services, wherein initiating the performance of the analysis includes:
performing the set of the plurality of application tests using a first execution test environment of a plurality of test environments; and
performing remaining application tests of the plurality of application tests using respective execution test environments of the plurality of execution test environments, wherein the remaining application tests exclude the set of the plurality of application tests;
initiating, by the execution broker application, a storage of at least one result of the analysis on another compute resource included in the computer network; and
deactivating, by the execution broker application, the first execution test environment and the respective execution test environments in response to determining the analysis has completed.

8. The non-transitory computer-readable storage medium of claim 7, wherein the analysis information includes data specifying a plurality of application code tests.

9-10. (canceled)

11. The non-transitory computer-readable storage medium of claim 7, wherein the analysis information includes test data, and further comprising, initiating, by the execution broker application, the performance of the analysis on the application code using the test data.

12. The non-transitory computer-readable storage medium of claim 7, wherein initiating, by the execution broker application, the storage of the at least one result includes initiating, by the execution broker application, generation of a durable Universal Resource Locator (URL).

13. The non-transitory computer-readable storage medium of claim 7, wherein the analysis information includes data specifying at least one an application code integration test.

14. A system, comprising:
one or more memories that, during operation, store instructions, and
one or more compute resources that, during operation, receive instructions from the one or more memories and execute the instructions to cause the system to perform operations comprising:
receiving, by an execution broker application executing on a compute resource included in a computer network, application code and analysis information that includes a plurality of application tests and test data;
identifying, by the execution broker application, a set of the plurality of application tests that use results from other application tests of the plurality of application tests;
generating, by the execution broker application, a plurality of execution test environments on respective different compute resources included in the computer network;
initiating, by the execution broker application and using the analysis information, a performance of an analysis of the application code that includes checking, within the application code, program calls that request access to external services, wherein initiating the performance of the analysis includes:
performing the set of the plurality of application tests using a first execution test environment of a plurality of execution test environments; and
performing remaining application tests of the plurality of application tests using respective execution test environments of the plurality of execution test environments, wherein the remaining application tests exclude the set of the plurality of application tests;
initiating, by the execution broker application, a storage of at least one result of the analysis on another compute resource included in the computer network; and
deactivating, by the execution broker application, the first execution test environment and the respective execution test environments in response to determining the analysis has completed.

15. The system of claim 14, wherein the analysis information includes data specifying a plurality of application code tests.

16-17. (canceled)

18. The system of claim 14, wherein the analysis information includes test data, and further comprising, initiating, by the execution broker application, the performance of the analysis on the application code using the test data.

19. The system of claim 14, wherein initiating, by the execution broker application, the storage of the at least one result includes initiating, by the execution broker application, generation of a durable Universal Resource Locator (URL).

20. The system of claim 14, wherein the analysis information includes data specifying at least one an application code integration test.
